(19) United States
(12) Patent Application Publication
(10) Pub. No.: US 2010/0248058 A1
(43) Pub. Date: Sep. 30, 2010

(54) FUEL CELL MODULE

(75) Inventors: Hiroaki SUZUKI, Kobe-shi (JP); Takashi Yasuo, Kobe-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/750,126

(22) Filed: Mar. 30, 2010

(30) Foreign Application Priority Data
Mar. 30, 2009 (JP) 2009-081956
Jan. 15, 2010 (JP) 2010-007278

(51) Int. Cl. H01M 8/04; H01M 8/10

(52) U.S. Cl. 429/442; 429/479

(57) ABSTRACT

A heat storage unit is provided between a gas sealing member and a hydrogen storage alloy tank, and is thermally connected to the gas sealing member and the hydrogen storage alloy tank. The latent heat storage unit includes a first heat storage material having a melting point (dry-out temperature) at or below which the dry-out begins during the operation of a fuel cell and a second heat storage material having a melting point (flooding temperature) at or below which the flooding begins during the operation of the fuel cell.

### CROSS-REFERENCE TO RELATED APPLICATIONS

This application is based upon and claims the benefit of priority from the prior Japanese Patent Applications No. 2009-081956, filed on Mar. 30, 2009 and Japanese Patent Applications No. 2010-007282, filed on Jan. 15, 2010, the entire contents of which are incorporated herein by reference.

### BACKGROUND OF THE INVENTION

1. Field of the Invention

The present invention relates to a fuel cell module.

2. Description of the Related Art

A fuel cell is a device that generates electricity from hydrogen and oxygen so as to obtain highly efficient power generation. A principal feature of a fuel cell is its capacity for direct power generation which does not undergo a stage of thermal energy or kinetic energy as in conventional power generation. This presents such advantages as high power generation efficiency despite the small scale setup, reduced emission of nitrogen compounds and the like, and environmental friendliness on account of minimal noise or vibration. A fuel cell is capable of efficiently utilizing chemical energy in its fuel and, as such, environmentally friendly. Fuel cells are therefore envisaged as an energy supply system for the twenty-first century and have gained attention as a promising power generation system that can be used in a variety of applications including space applications, automobiles, mobile devices, and large and small scale power generation. Serious technical efforts are being made to develop practical fuel cells.

In particular, polymer electrolyte fuel cells feature lower operating temperature and higher output density than the other types of fuel cells. In recent years, therefore, the polymer electrolyte fuel cells have been emerging as a promising power source for mobile devices such as cell phones, notebook-size personal computers, PDAs, MP3 players, digital cameras, electronic dictionaries or electronic books. Well known as the polymer electrolyte fuel cells for mobile devices are planar fuel cells, which have a plurality of single cells arranged in a plane. And as a fuel to be used for this type of fuel cells, hydrogen stored in a hydrogen storage alloy or a hydrogen cylinder, as well as methanol, is the subject of continuing investigations.

In general, a fuel cell suffers from a phenomenon called a dry-out in which the electrolyte membrane dries out when the cell temperature is too high and, conversely, it suffers from another phenomenon called a flooding in which the water is condensed when the cell temperature is too low. The power generation performance declines due to these phenomena. To countermeasure these phenomena, a known technique is used wherein the cell temperature is raised by the use of a heater or the cell temperature is lowered by the use of cooling fins. Such a conventional technique complicates the structure for restricting the dry-out and the flooding, thus causing a problem where it becomes hard to reduce the size of fuel cells used for mobile devices.

In another conventional technique, for example, known is a fuel cell having a latent heat storage agent which reversibly absorbs the heat generated at the time of power generation. However, the latent heat storage agent used is of a single type. In other words, the melting point of the latent heat storage agent is a single point. Hence, such a conventional technique cannot handle both the dry-out and the flooding.

### SUMMARY OF THE INVENTION

The present invention has been made in view of the foregoing problems, and a purpose thereof is to provide a fuel cell module, of a simpler configuration, capable of reducing the dry-out and the flooding.

One embodiment of the present invention relates to a fuel cell module. The fuel cell module comprises: a fuel cell including an electrolyte membrane, an anode disposed on one face of the electrolyte membrane and a cathode disposed on the other face of the electrolyte member; a fuel containing unit configured to store hydrogen storage alloy for storing hydrogen to be supplied to the fuel cell; and a latent heat storage unit including a first heat storage material having a melting point at or below which a dry-out begins during an operation of the fuel cell and a second heat storage material having a melting point at or above which a flooding begins during an operation of the fuel cell, wherein the latent heat storage unit is thermally connected to the fuel cell and the fuel containing unit.

According to this embodiment, as the temperature of the fuel cell reaches the melting point of the first heat storage material, the temperature rise of the fuel cell is suppressed by the heat absorption caused by the melting of the first heat storage material and therefore the occurrence of dry-out can be restricted. Also, as the temperature of the fuel cell drops down to the melting point of the second heat storage material, the temperature drop of the fuel cell is suppressed by the heat generation caused by the solidification of the second heat storage material and therefore the occurrence of flooding can be restricted. In other words, the dry-out and flooding can be minimized by employing a simpler structure without the use of the components like the heater or cooling fins. Since the latent heat storage unit is thermally connected to the fuel containing unit, the following advantageous effects are achieved. That is, while the fuel cell generates electric power, hydrogen is released from the hydrogen storage alloy stored in the fuel containing unit, which in turn causes the absorption of heat. Accordingly, the heat stored in the latent heat storage unit is absorbed, thereby further sustaining the heat storage effect of the latent heat storage unit. Also, when the fuel containing unit is refueled with hydrogen while the operation of the fuel cell is stopped, the refueling of hydrogen into the hydrogen storage alloy generates heat. This heat enables the solidified heat storage material to be melted and enables the fuel containing unit to be cooled. As a result, the time required for the refueling of hydrogen can be reduced and can prevent the electrolyte membrane from being dried out.

In the above-described embodiment, the latent heat storage unit, including the first heat storage material and the second heat storage material, may contain a flexible material. Also, the latent heat storage may contain the first heat storage material and the second heat storage material such that the amount of the first heat storage material is greater than that of the second heat storage material, in a region corresponding to a middle region of the fuel cell, and the latent heat storage may contain the first heat storage material and the second heat storage material such that the amount of the second heat storage material is greater than that of the first heat storage material, in a region corresponding to a peripheral region of the fuel cell. Also, the latent heat storage may be demarcated into a plurality of portions from those corresponding to a middle region of the fuel cell toward those corresponding to a peripheral region, and the content ratio of the second heat storage material in each of the portions may gradually increase starting from a portion corresponding to the middle region toward a portion corresponding to an outermost region. Also, the melting point of the first heat storage material may be less than or equal to a lower limit of a temperature at which a dry-out begins in a predetermined humidity range, and the melting point of the second heat storage material may be greater than or equal to an upper limit of a temperature at which a flooding begins in a predetermined humidity range.

The fuel cell module may further comprise: a temperature sensor configured to measure the temperature of the fuel cell; and a control unit configured to lower an output of the fuel cell when the temperature measured by the temperature sensor rises to reach the melting point of the first heat storage material, and configured to raise the output of the fuel cell when the temperature measured by the temperature sensor drops to reach the melting point of the second heat storage material.

Also, the latent heat storage unit may include a plurality of first heat storage materials having a plurality of different melting points and a plurality of second heat storage materials having a plurality of different melting points; at least one of the plurality of first heat storage materials may be a heat storage material, for use in restricting the dry-out, which has a melting point less than or equal to an upper limit of a temperature at which the dry-out begins, in different humidity ranges; and at least one of the plurality of second heat storage materials may be a heat storage material, for use in restricting the flooding, which has a melting point greater than or equal to an upper limit of a temperature at which the flooding begins, in different humidity ranges.

The fuel cell module may further comprise: a temperature sensor configured to measure the temperature of the fuel cell; a humidity sensor configured to measure the humidity of the fuel cell; and a control unit configured to lower an output of the fuel cell when the temperature measured by the temperature sensor rises to reach the melting point of the dry-out restricting heat storage material in a humidity range containing the humidity measured by the humidity sensor, and configured to raise an output of the fuel cell when the temperature measured by the temperature sensor drops to reach the melting point of the flooding-restricting heat storage material in a humidity range containing the humidity measured by the humidity sensor.

It is to be noted that any arbitrary combinations or rearrangement, as appropriate, of the aforementioned constituting elements and so forth are all effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a perspective view showing the appearance of a fuel cell module according to a first embodiment of the present invention;

FIG. 2 is a cross-sectional view taken along the line A-A of FIG. 1;

FIG. 3 a schematic illustration showing a structure of a latent heat storage unit;

FIG. 4 conceptually illustrates a control of temperature performed by a latent heat storage unit;

FIG. 5 is a graph showing a change in cell temperature with time in a conventional fuel cell module;

FIG. 6 is a graph showing a change in cell temperature with time in a fuel cell module using a latent storage unit;

FIG. 7 is a graph showing the dependence of dry-out temperature T2 and flooding temperature T1 on humidity;

FIG. 8 is a perspective view showing the appearance of a fuel cell module according to a second embodiment of the present invention;

FIG. 9 is a cross-sectional view taken along the line A-A of FIG. 8;

FIG. 10 is a schematic illustration showing a structure of a latent heat storage unit used for a fuel cell module according to a second embodiment of the present invention;

FIG. 11 is a graph showing the dependence of dry-out temperature T2 and flooding temperature T1 on humidity, and the melting point of each heat storage material contained in a latent heat storage unit;

FIG. 12 is a cross-sectional view of a fuel cell module according to a third embodiment of the present invention; and

FIG. 13 is a perspective view showing a structure of a latent heat storage unit used for a fuel cell module according to a third embodiment of the present invention.

### DETAILED DESCRIPTION OF THE INVENTION

The invention will now be described by reference to the preferred embodiments. This does not intend to limit the scope of the present invention, but to exemplify the invention.

The preferred embodiments of the present invention will be described with reference to accompanying drawings. Note that in all the Figures, the same reference numbers are used to indicate the same or similar component elements and the description thereof is omitted as appropriate.

### First Embodiment

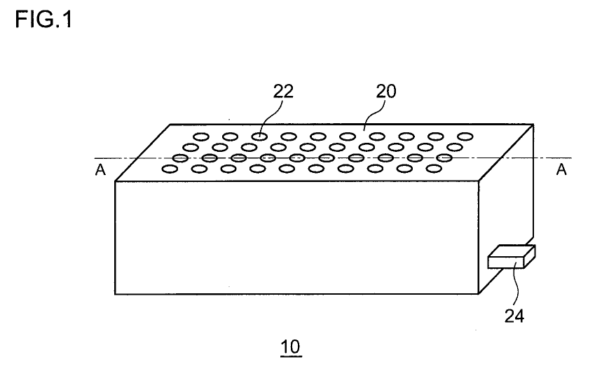

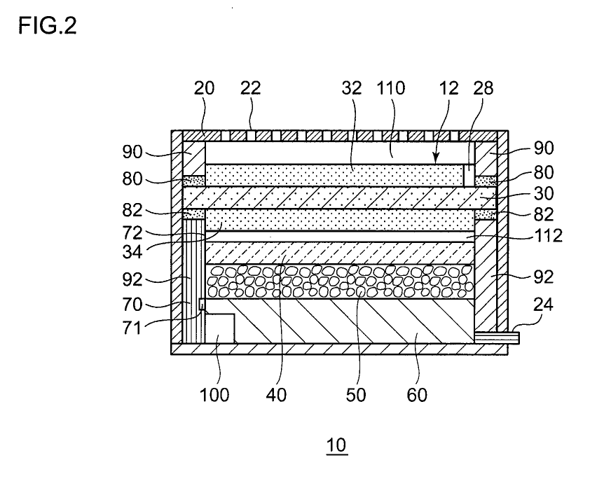

FIG. 1 is a perspective view showing the appearance of a fuel cell module according to a first embodiment of the present invention. FIG. 2 is a cross-sectional view taken along the line A-A of FIG. 1.

A fuel cell module 10 includes, as principal components, a housing 20, a membrane electrode assembly 12 housed in the housing 20, a hydrogen storage alloy tank 60, and a latent heat storage unit 50. Note that the membrane electrode assembly 12 is a part of the “fuel cell” or the “fuel cell” in its entirety described in this patent specification.

On a surface disposed opposite to a cathode side of the membrane electrode assembly 12 (the upper part in FIG. 1 and FIG. 2), the housing 20 is provided with a plurality of air inlets 22. Through the air inlets 2, air serving as an oxidant can flow into the housing 20 from outside.

In the vicinity of a side surface disposed opposite to the air inlets 22 (the lower part in FIG. 1 and FIG. 2), the housing 22 is also provided with a hydrogen refueling inlet 24. The hydrogen refueling inlet 24 communicates with the hydrogen storage alloy tank 60; when an external cylinder (not shown) filled with hydrogen is connected to the hydrogen refueling inlet 24, hydrogen can be injected into the hydrogen storage alloy tank 60.

The membrane electrode assembly 12 includes a electrolyte membrane 30, a cathode catalyst layer 32, and an anode catalyst layer 34.

The electrolyte membrane 30, which may show excellent ion conductivity in a moist or humidified condition, functions as an ion-exchange membrane for the transfer of protons between the cathode catalyst layer 32 and the anode catalyst layer 34. The electrolyte membrane 30 is formed of a solid polymer material such as a fluorine-containing polymer or a nonfluorine polymer. The material that can be used is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is a Nafion ionomer dispersion (made by DuPont: registered trademark) 112. Also, an example of the nonfluorine polymer is a sulfonated aromatic polyether ether ketone, polysulfone or the like. The thickness of the electrolyte membrane 30 may be about 10 to 200 μm, for instance.

The cathode catalyst layer 32 is formed on one face of the electrolyte membrane 22. Air is supplied to the cathode catalyst layer 32 from outside through the air inlets 22. The anode catalyst layer 34 is formed on the other face of the electrolyte membrane 30. Hydrogen released from the hydrogen storage alloy tank 60 is supplied to the anode catalyst layer 34. A single cell is structured by a pair of cathode catalyst layer 32 and anode catalyst layer 34 with the electrolyte membrane 30 held between the cathode catalyst layer 32 and the anode catalyst layer 34. Each single cell generates electric power through an electrochemical reaction between the fuel (e.g. hydrogen) and oxygen in the air.

The cathode catalyst layer 32 and the anode catalyst layer 34 are each provided with ion-exchange material and catalyst particles or carbon particles as the case may be.

The ion-exchange material provided in the cathode catalyst layer 32 and the anode catalyst layer 34 may be used to promote adhesion between the catalyst particles and the electrolyte membrane 30. This ion-exchange material may also play a role of transferring protons between the catalyst particles and the electrolyte membrane 30. The ion-exchange material may be formed of a polymer material similar to that of the electrolyte membrane 30. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Furnace black, acetylene black, ketjen black, carbon nanotube or the like may be used as the carbon particle when a catalyst is to be supported. The thickness of the cathode catalyst layer 32 and the anode catalyst layer 34 may be from about 10 to 40 μm, for instance.

A gasket 80 is provided between the electrolyte membrane 30 disposed around the cathode catalyst layer 32 (the outer periphery of the electrolyte membrane 30 on the cathode side) and a cathode-side securing member 90 provided on an inner periphery-side surface of the housing 20 on the cathode side. Provision of the gasket 80 enhances the sealing performance of an air chamber 110.

A gasket 82 is provided between the electrolyte membrane 30 disposed around the anode catalyst layer 34 (the outer periphery of the electrolyte membrane 30 on the anode side) and an anode-side securing member 92 provided on an inner periphery-side surface of the housing 20 on the anode side. Provision of the gasket 82 enhances the sealing performance of a fuel gas chamber 112 and therefore prevents the leakage of the fuel.

Inside the housing 20, a sheet-like gas seal member 40 is disposed counter to the anode catalyst layer 34.

The fuel gas chamber 112 serving as a space in which hydrogen is filled is formed between the gas seal member 40 and the anode catalyst layer 34. Provision of the gas seal member 40 enhances the sealing performance of the fuel gas chamber 112. The material used for the gas seal member 40 may be one that can block the flow of hydrogen and, at the same time, can transfer the heat transferred from the membrane electrode assembly 12, to the latent heat storage unit 50. An example of such a material used for the gas seal member 40 is a metallic sheet such as stainless steel (SUS) or aluminum. The gas seal member 40 is part of the “fuel cell”.

The hydrogen storage alloy tank (fuel containing unit) 60 is provided on an inner periphery surface side of the housing 20 disposed counter to the anode side of the membrane electrode assembly 12. Housed in the hydrogen storage alloy tank 60 is a hydrogen storage alloy which can store hydrogen within itself (e.g., rare-earth Mm (misch metal) Ni_{4.32}Mn_{0.18}Al_{0.1}Fe_{0.1}Co_{0.3}). Note that the hydrogen storage alloy is not limited to a rare-earth-based compound, but may include a Ti—Mn, Ti—Fe, Ti—Zr, Mg—Ni or Zr—Mn based materials, for instance.

A temperature sensor 28, which is disposed in a position facing the air chamber 110, is provided near the cathode catalyst layer 32. The temperature sensor 28 detects the temperature of the fuel cell. Data on the temperatures detected by the temperature sensor 28 is transmitted to a control unit 100.

The interior of the hydrogen storage alloy tank 60 communicates with the fuel gas chamber 112 through a hydrogen supply passage 70. More specifically, the hydrogen passage 70 is provided along the inner periphery of the housing 20 on the anode side; at one end of the hydrogen supply passage 70, the hydrogen supply passage 70 and the interior of the hydrogen storage alloy tank 60 communicates with each other via a regulator 71. The regulator 71 reduces the pressure of hydrogen supplied to the fuel gas chamber 112, thereby protecting the anode catalyst layer 34, when hydrogen is supplied to the hydrogen storage alloy from an external cylinder and when hydrogen is released from the hydrogen storage alloy. Also, at the other end of the hydrogen supply passage 70, there is provided a hydrogen supply port 72 communicating the hydrogen supply passage 70 to the fuel gas chamber 112.

The control unit 100 adjusts the amount of hydrogen to be supplied from the hydrogen storage alloy tank 60 to the fuel gas chamber 112, by controlling the opening degree of the regulator 71. In this manner, the control unit 100 controls the output of the fuel cell.

The latent heat storage unit 50 contains a heat storage material that undergoes an endothermic reaction when melted and undergoes an exothermal reaction when solidified.

In the heat storage material, the energy is consumed at a phase transition of a material. The thermal energy added when the temperature of the heat storage material reaches near the melting point is consumed for the phase transition, so that there is a region where the temperature remains constant. This can prevent the temperature of the heat storage material from changing beyond (or below) the melting point thereof.

The latent heat storage unit 50 is provided between the gas seal member 40 and the hydrogen storage alloy tank 60, and is thermally connected to the gas seal member 40 and the hydrogen storage alloy tank 60. The latent heat storage unit 50 is preferably in contact with a main surface of the gas seal member 40 disposed opposite to the anode catalyst layer 34 and in contact with an outer peripheral surface of the hydrogen storage alloy tank 60 on the anode catalyst layer 34 side. Such an arrangement can enhance the heat transference between the latent heat storage unit 50 and the gas seal member 40 as well as the heat transference between the latent heat storage unit 50 and the hydrogen storage alloy tank 60.

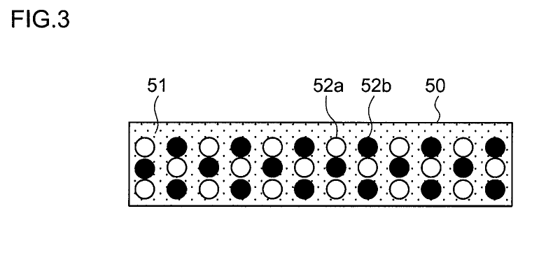

FIG. 3 schematically shows a structure of the latent heat storage unit 50. The latent heat storage unit 50 includes a gel-like sheet 51, a first heat storage material 52a, and a second heat storage material 52b.

The gel-like sheet 51 is a material including the first heat storage materials 52a and the second heat storage materials 52b therein. Also, the gel-like sheet 51 has flexibility and shape conformability. An example of the gel-like sheet 51 is a silicon rubber sheet. The gel-like sheet 51 can improve the adhesion between the latent heat storage unit 50 and the gas seal member 40 as well as the adhesion between the latent heat storage unit 50 and the hydrogen storage alloy tank 60. In particular, the hydrogen storage alloy tank 60 changes its volume due to the release of hydrogen. Thus the flexibility and the shape conformability given to the latent heat storage unit 50 reduces a space between the latent heat storage unit 50 and the hydrogen storage alloy tank 60 if such a space is created as a result of the change in volume of the hydrogen storage alloy tank 60. Hence, giving the flexibility and the shape conformability achieves a significant advantageous effect in this respect.

Heat storage microcapsules may be used as the first heat storage materials 52a and the second heat storage materials 52b. The heat storage microcapsule is a heat storage material having such a structure that the heat storage material contains an organic heat storage material in a microcapsule made of resin. A desired temperature setting can be done by adjusting the melting point of the organic heat storage material.

Examples of the organic heat storage material include aliphatic hydrocarbon compound, alcohol, ester, fatty acid, and so forth. A normal paraffin which is a compound having the following characteristics (1) to (3) is preferably used.

(1) Every time the number of carbons that constitute the compound increases, the melting point rises so that the melting point can be fractionally set.

(2) It is relatively easy to be microencapsulated.

(3) An arbitrary melting point can be set by mixing a plurality of compounds together.

The size (particle diameter) of a microcapsule can be set as appropriate in such a manner that the type and concentration of emulsifier used in fabricating the capsule, the temperature of emulsified liquid at the time of emulsification, the emulsification ratio (the ratio of aqueous phase to oil phase), conditions of operation (e.g., the number of stirring rotations and stirring time) in a so-called atomization apparatus, such as an emulsifying apparatus and a dispersion apparatus, and so forth are adjusted as appropriate. The size of a microcapsule is preferably 10 μm or below. In other words, the size thereof exceeding 10 μm is undesirable because the microcapsule may be easily damaged by the outside pressure when the size of a microcapsule exceeds 10 μm.

The first heat storage material 52a is a heat storage material that has a melting point (melting temperature) at or below which a dry-out begins to occur during an operation of the fuel cell. This temperature at which the dry-out begins will be hereinafter referred to as “dry-out temperature” also. On the other hand, the second heat storage material 52b is a heat storage material that has a melting point (melting temperature) at or above which a flooding begins to occur during an operation of the fuel cell. This temperature at which the flooding begins will be hereinafter referred to as “flooding temperature” also.

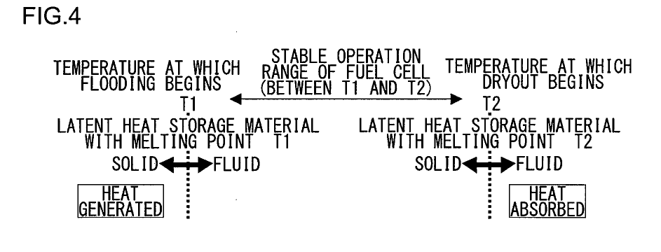

FIG. 4 conceptually illustrates a control of temperature performed by the latent heat storage unit 50. As the cell temperature rises and reaches a temperature T2 at which the dry-out begins to occur, the absorption of heat by the melting of a latent heat storage material having the melting point T2 (first heat storage material 52a) is caused, so that the rise in cell temperature is restricted. While the rise in cell temperature is being suppressed, the control unit 100 lowers the output of the fuel cell so as to lower the cell temperature. As a result, the occurrence of dry-out can be avoided.

On the other hand, as the cell temperature drops and reaches a temperature T1 at which the flooding begins to occur, the absorption of heat by the solidification of a latent heat storage material having the melting point T1 (second heat storage material 52b) is caused, so that the drop in cell temperature is restricted. While the drop in cell temperature is being suppressed, the control unit 100 raises the output of the fuel cell so as to increase the cell temperature. As a result, the occurrence of flooding can be avoided.

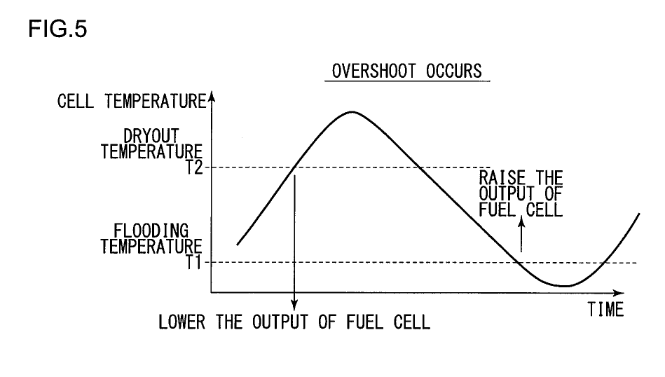

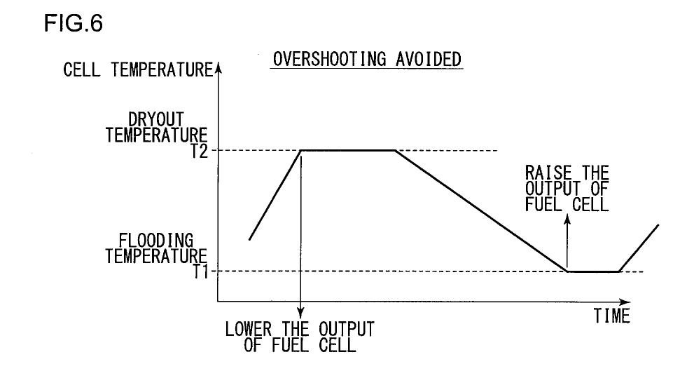

FIG. 5 is a graph showing a change in cell temperature with time in a conventional fuel cell module. On the other hand, FIG. 6 is a graph showing a change in cell temperature with time in the fuel cell module 10 using the above-described latent storage unit 50.

As shown in FIG. 5, in the conventional fuel cell module, the cell temperature rises, and even though the output of the fuel cell is lowered at the point exceeding the dry-out temperature T2, the cell temperature does not drop immediately but continues to rise for a while and therefore an overshoot occurs. Thus, a dry-out is caused in the conventional fuel cell module.

On the other hand, as shown in FIG. 6, in the fuel cell module 10 according to the present embodiment, the absorption of heat by the melting of the heat storage material (first heat storage material 52a) whose melting point is T2 occurs at the dry-out temperature T2. Thus, the rise in the cell temperature is restricted and the overshoot as shown in FIG. 5 is prevented. The output of the fuel cell is lowered while the temperature (cell temperature) detected by the temperature sensor 28 is being kept constant at the dry-out temperature T2. This enables the occurrence of an overshoot to be avoided and enables the cell temperature to drop to the dry-out temperature T2 or below. As a result, the occurrence of dry-out can be avoided even through the temperature varies due to a sudden load variation.

On the other hand, at the flooding temperature T1, heat is generated by the solidification of the latent heat storage material (second heat storage material 52b) whose melting point is T1. Thus, the output of the fuel cell is raised while the temperature (cell temperature) detected by the temperature sensor 28 is being kept constant at the flooding temperature T1. This enables the occurrence of an overshoot to be avoided and enables the cell temperature to rise to the flooding temperature T1 or above. As a result, the occurrence of flooding can be avoided even through the temperature varies due to a sudden load variation.

A description is now given of advantageous effects achieved by the structure where the latent heat storage unit 50 is thermally connected to the hydrogen storage alloy tank 60. While the fuel cell generates electricity, hydrogen is released from the hydrogen storage alloy stored in the hydrogen storage alloy tank 60. The heat is absorbed when hydrogen is released from the hydrogen storage alloy. Thus the heat accumulated in the latent storage unit 50 is absorbed, so that the heat storage effect of the latent heat storage unit 50 can be sustained. In particular, if a mobile device is to be used, the absorption of heat by the hydrogen storage alloy tank 60 plays a crucial part. For example, even though the mobile device is to be cooled by the use of a radiating means such as a heatsink, heat will stay on inside the mobile device where there is little space for heat to escape. As a result, the cooling function of the heatsink drops. Accordingly, the heat storage effect of the latent heat storage unit 50 does not last long enough. In contrast thereto, the hydrogen storage alloy tank 60 can maintain a constant heat absorption level through the release of hydrogen, so that the heat storage effect of the latent heat storage unit 50 can be maintained.

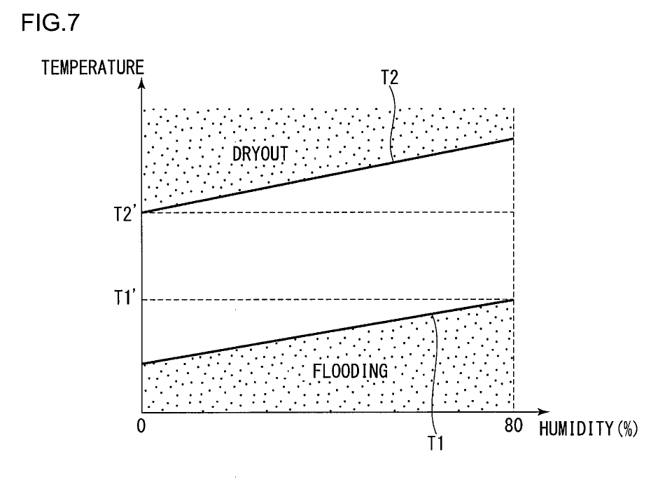

Next, a description is given of a control of temperature performed by the latent heat storage unit 50 in consideration of a change in humidity of the outside environment. FIG. 7 is a graph showing the dependence of dry-out temperature T2 and flooding temperature T1 on the humidity. As the humidity increases, the dry-out temperature T2 and the flooding temperature T1 rise. Thus the start temperatures of dry-out and flooding of the fuel cell vary depending on the humidity. For example, since the flooding temperature T1 increases under the condition of high humidity, flooding is more likely to occur. Thus, the temperature needs to be controlled according to a change in the outside environment.

In FIG. 7, a temperature T2′ is a lower limit of the dry-out temperature T2 (a dry-out temperature under a low-humidity condition where the humidity is 20%, for instance). Also, a temperature T1′ is an upper limit of the flooding temperature T1 (a flooding temperature under a high-humidity condition where the humidity is 80%, for instance). As shown in FIG. 7, even though the humidity varies, neither of dry-out and flooding occurs in a temperature range of temperature T1′ to temperature T2′. This indicates that the temperature range of temperature T1′ to temperature T2′ is a temperature range where the fuel cell can stably generate electricity independently of humidity.

From the above-described observation, the melting point of the first heat storage material 52a and that of the second heat storage material 52b both shown in FIG. 3 are set to T2′ and T1′, respectively, so that the fuel cell can be stably operated without relying on the humidity.

To describe it in more detail, strictly speaking it is desirable that the melting point of the first heat storage material 52a used to prevent the dry-out is set to a temperature at least 1° C. or so lower than the temperature T2′. For example, if the temperature T2′ is about 55° C., pentacosane whose melting point is 53.0° C. may be used as the first heat storage material 52a. Also, it is desirable that the melting point of the first heat storage material 52b used to prevent the flooding is set to a temperature at least 1° C. or so higher than the temperature T1′. For example, if the temperature T2′ is about 45° C., tricosane whose melting point is 47.7° C. may be used as the second heat storage material 52b.

A concept of temperature control in consideration of the humidity is basically the same as the concept illustrated in FIG. 4. That is, as the cell temperature rises and reaches the temperature T2′, the absorption of heat by the melting of a latent heat storage material having the melting point T2′ (first heat storage material 52a) is caused, so that the rise in cell temperature is restricted. While the rise in cell temperature is being suppressed, the output of the fuel cell is lowered so as to lower the cell temperature. As a result, the occurrence of dry-out can be avoided.

On the other hand, as the cell temperature drops and reaches the temperature T1′, the absorption of heat by the solidification of a latent heat storage material having the melting point T1′ (second heat storage material 52b) is caused, so that the drop in cell temperature is restricted. While the drop in cell temperature is being suppressed, the output of the fuel cell is raised so as to increase the cell temperature. As a result, the occurrence of flooding can be avoided.

A description is now given of advantageous effects achieved by performing the above-described control in consideration of the change in humidity. By employing the above-described structure, the temperature control according to the change in humidity can be performed without provision or use of a humidity sensor, so that the structure of the fuel cell module can be simplified and made easy to use. Also, in order to perform a control to stably operate the fuel cell, it is only necessary that the output of the fuel cell be raised when the cell temperature falls down to the temperature T1′ and the output of the fuel cell be lowered when the cell temperature rises to the temperature T2′. Hence, simple and easy control can be performed without the need of complex control schemes or equipment.

Besides the above effects, a description is now given of an additional advantageous effect thereof while the fuel cell is not generating electricity. When the hydrogen storage alloy tank 60 is refueled with hydrogen while the operation of the fuel cell is stopped, heat is generated. This heat can not only melt the solidified heat storage materials but also cool the hydrogen storage alloy tank 60. As a result, the time required for the refueling of hydrogen into the hydrogen storage alloy can be shortened and the electrolyte membrane 30 can be prevented from being dried.

### Second Embodiment

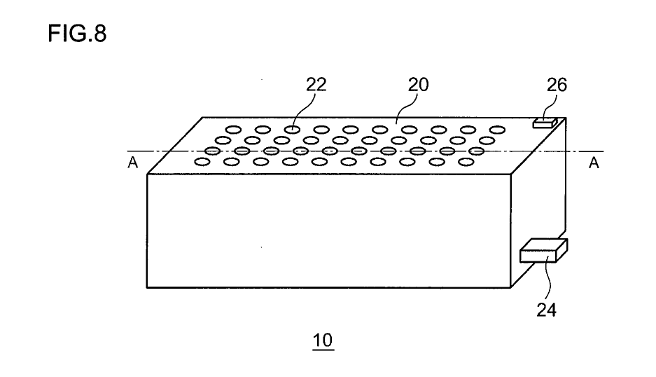

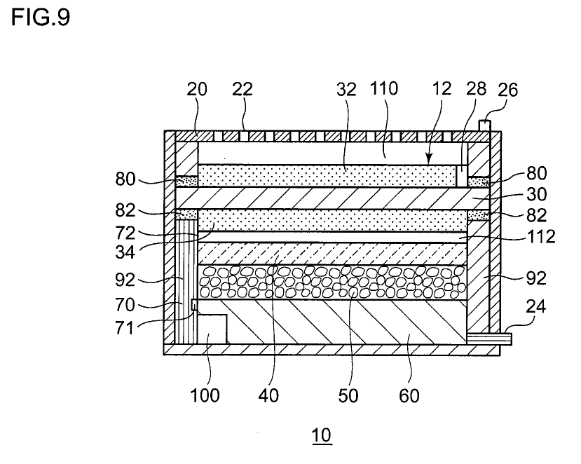

FIG. 8 is a perspective view showing the appearance of a fuel cell module according to a second embodiment of the present invention. FIG. 9 is a cross-sectional view taken along the line A-A of FIG. 8. A fuel cell according to the second embodiment of the present invention is basically the same as that according to the first embodiment. Hence, a description of structural components of the fuel cell module according to the second embodiment identical to those of the fuel cell module according the first embodiment will be omitted as appropriate.

As shown in FIG. 8, in a fuel cell module 10 according to the second embodiment, a humidity sensor 26 is installed in the housing 20 near the air inlets 22. The humidity sensor 22 detects the humidity of environment where the housing 20 is placed. The humidity detected by the humidity sensor 26 is transmitted to the control unit 100.

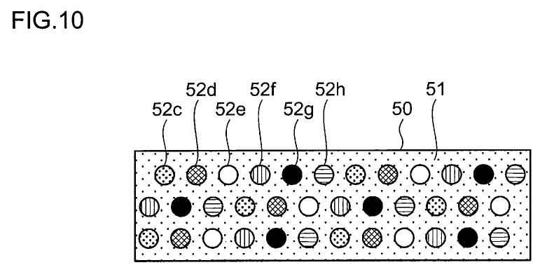

FIG. 10 is a schematic illustration showing a structure of the latent heat storage unit 50 used for the fuel cell module 10 according to the second embodiment of the present invention. The latent heat storage unit 50 includes a gel-like sheet 51, a first heat storage material 52c (hereinafter referred to as “heat storage material C”), a first heat storage material 52d (hereinafter referred to as “heat storage material D”), a first heat storage material 52e (hereinafter referred to as “heat storage material E”), a second heat storage material 52f (hereinafter referred to as “heat storage material F”), a second heat storage material 52g (hereinafter referred to as “heat storage material G”), and a second heat storage material 52h (hereinafter referred to as “heat storage material H”). The heat storage materials C and the heat storage materials E are used to prevent the dry-out. Also, the heat storage materials F and the heat storage materials H are used to prevent the flooding.

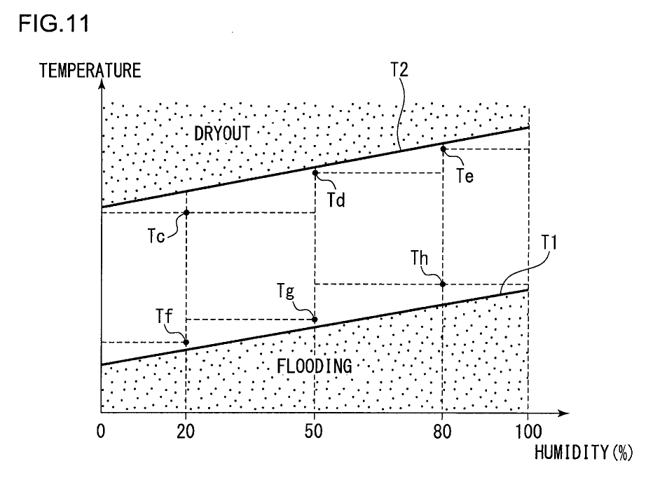

FIG. 11 is a graph showing the dependence of dry-out temperature T2 and flooding temperature T1 on humidity, and the melting point of each heat storage material contained in the latent heat storage unit 50. A melting point Tc of the heat storage material C is approximately equal to or lower than the dry-out temperature by at least about 1 degree in a low humidity condition (e.g., 20%). A melting point Td of the heat storage material D is approximately equal to or lower than the dry-out temperature by at least about 1 degree in a middle humidity condition (e.g., 50%). A melting point Te of the heat storage material E is approximately equal to or lower than the dry-out temperature by at least about 1 degree in a high humidity condition (e.g., 80%).

A melting point Tf of the heat storage material F is approximately equal to or higher than the flooding temperature by at least about 1 degree in a low humidity condition (e.g., 20%). A melting point Tg of the heat storage material G is approximately equal to or higher than the flooding temperature by at least about 1 degree in a middle humidity condition (e.g., 50%). A melting point Th of the heat storage material H is approximately equal to or higher than the flooding temperature by at least about 1 degree in a high humidity condition (e.g., 80%).

Table 1 shows the dry-out temperature and flooding temperature assumed in each humidity level. Table 2 shows an example of material and the melting point of the specific example for each heat storage material. Table 3 shows a combination of heat storage materials by which the temperature is controlled in each humidity range.

TABLE 1

| | DRY-OUT | FLOODING |
|---|---|---|
| | TEMPERATURE | TEMPERATURE |
| HUMIDITY | ASSUMED | ASSUMED |
| 20% | ABOUT 55° C. | ABOUT 40° C. |
| 50% | ABOUT 58° C. | ABOUT 43° C. |
| 80% | ABOUT 60° C. | ABOUT 45° C. |

TABLE 2

| HEAT STORAGE | | |
|---|---|---|
| MATERIAL | MATERIAL NAME | MELTING POINT |
| C | PENTACOSANE | 53.0° C. |
| D | HEXACOSANE | 56.3° C. |
| E | HEPTACOSANE | 59.5° C. |
| F | HENICOSANE | 40.5° C. |
| G | DOCOSANE | 44.0° C. |
| H | TRICOSANE | 47.7° C. |

TABLE 3

| HUMIDITY RANGE OF AIR | HEAT STORAGE MATERIALS BY |
|---|---|
| (DETECTED BY THE | WHICH TO CONTROL THE |
| HUMIDITY SENSOR) | TEMPERATURE |
| 20% OR LESS | C AND F |
| 20%-50% | C AND G |
| 50%-80% | D AND H |
| HIGHER THAN 80% | E AND H |

Where the humidity range is less than 20%, the heat storage material C takes charge of controlling the temperature to suppress the dry-out, whereas the heat storage material F takes charge of controlling the temperature to suppress the flooding. More specifically, if the humidity detected by the humidity sensor 26 is less than 20%, the control unit 100 will lower the output of the fuel cell while the temperature (cell temperature) detected by the temperature sensor 28 remains constant at the melting point Tc of the heat storage material C. Also, the control unit 100 raises the output of the fuel cell while the temperature (cell temperature) detected by the temperature sensor 28 remains constant at the melting point Tf of the heat storage material F. Note that the melting point of the heat storage material C is the dry-out temperature or below, in the lower limit of the humidity, e.g., the humidity of 0%. In this manner, the temperature can be controlled in a wider range of humidity levels.

Where the humidity range is 20% to 50%, the heat storage material C takes charge of controlling the temperature to suppress the dry-out, whereas the heat storage material G takes charge of controlling the temperature to suppress the flooding. That is, the melting point of the heat storage material C is the lower limit of the dry-out temperature or below, in the humidity range of 20% to 50%. Also, the melting point of the heat storage material G is the upper limit of the flooding temperature or above, in the humidity range of 20% to 50%. If the humidity detected by the humidity sensor 26 is in the range of 20% to 50%, the control unit 100 will lower the output of the fuel cell while the temperature (cell temperature) detected by the temperature sensor 28 remains constant at the melting point Tc of the heat storage material C. Also, the control unit 100 raises the output of the fuel cell while the temperature (cell temperature) detected by the temperature sensor 28 remains constant at the melting point Tg of the heat storage material G.

Where the humidity range is 50% to 80%, the heat storage material D takes charge of controlling the temperature to suppress the dry-out, whereas the heat storage material H takes charge of controlling the temperature to suppress the flooding. That is, the melting point of the heat storage material D is the lower limit of the dry-out temperature or below, in the humidity range of 50% to 80%. Also, the melting point of the heat storage material H is the upper limit of the flooding temperature or above, in the humidity range of 50% to 80%. If the humidity detected by the humidity sensor 26 is in the range of 50% to 80%, the control unit 100 will lower the output of the fuel cell while the temperature (cell temperature) detected by the temperature sensor 28 remains constant at the melting point Td of the heat storage material D. Also, the control unit 100 raises the output of the fuel cell while the temperature (cell temperature) detected by the temperature sensor 28 remains constant at the melting point Th of the heat storage material H.

Where the humidity range is higher than 80%, the heat storage material E takes charge of controlling the temperature to suppress the dry-out, whereas the heat storage material H takes charge of controlling the temperature to suppress the flooding. Note that the melting point of the heat storage material H is the flooding temperature or above, in the upper limit of the humidity, e.g., the humidity of 100%. If the humidity detected by the humidity sensor 26 is higher than 80%, control is performed to lower the output of the fuel cell while the temperature (cell temperature) detected by the temperature sensor 28 remains constant at the melting point Te of the heat storage material E. Also, control is performed to raise the output of the fuel cell while the temperature (cell temperature) detected by the temperature sensor 28 remains constant at the melting point Th of the heat storage material H. In this manner, the temperature can be controlled in a wider range of humidity levels.

By employing the second embodiment, the respective heat storage materials suitable for the use in suppressing the dry-out and the flooding take charge of controlling the temperature according to the humidity range assumed. Thus, the temperature range over which the fuel cell can be operated stably can be widened for each humidity range. In other words, the fuel cell can be operated in a temperature range closer to the original stable operating range.

### Third Embodiment

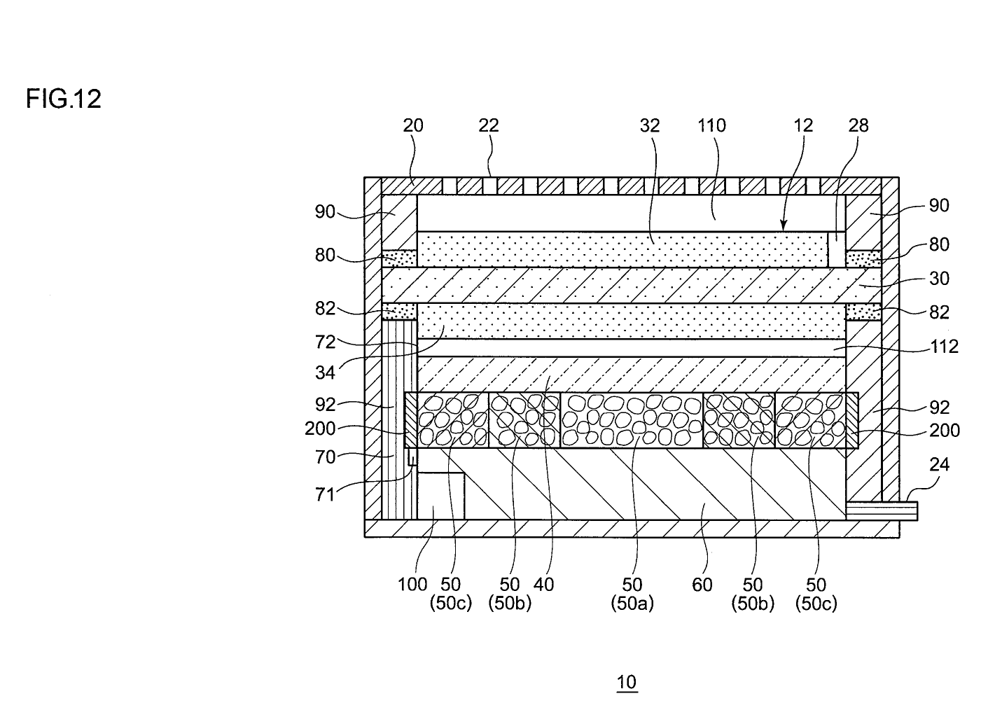

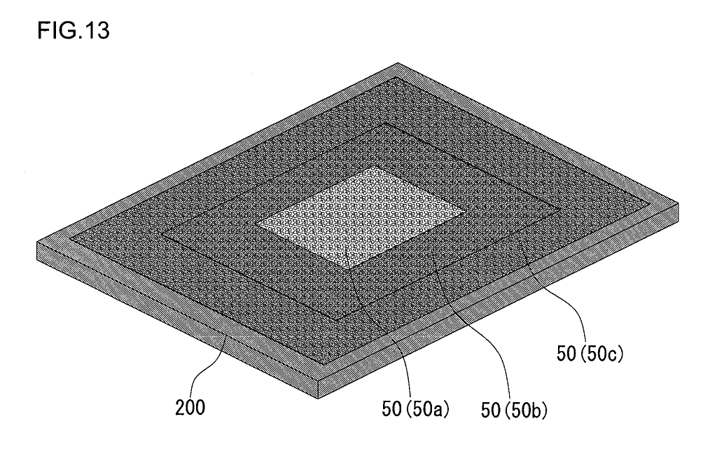

FIG. 12 is a cross-sectional view of a fuel cell module according to a third embodiment of the present invention. FIG. 13 is a perspective view showing a structure of a latent heat storage unit used for a fuel cell module according to the third embodiment.

In the third embodiment, the latent heat storage unit 50, which is fixed within a heat-storage-material securing frame 200, is divided into three different regions (sections) which are a latent heat storage unit 50a, latent heat storage units 50b and latent heat storage units 50c. The heat-storage-material securing frame 200 is formed of a metallic material, a resin material or the like.

The latent heat storage unit 50a is provided in a region of the latent heat storage unit 50 corresponding to a middle region of the fuel cell module 10. The latent heat storage units 50b are provided around the latent heat storage unit 50a. The latent heat storage units 50c are provided around the latent heat storage units 50b. In other words, the latent heat storage units 50c are provided in regions of the latent heat storage unit 50 corresponding to the outer peripheral regions of the fuel cell module 10.

In the latent heat storage unit 50a, the content (wt. %) of the heat storage material used to prevent the flooding is greater than that of the heat storage material used to prevent the dry-out. In the latent heat storage units 50b, the content (wt. %) of the flooding preventing heat storage material is equal to that of the dry-out preventing heat storage material. In the latent heat storage units 50c, the content (wt. %) of the flooding preventing heat storage material is less than that of the dry-out preventing heat storage material. In other words, the heat latent storage unit 50 is segmentalized into a plurality of sections starting from a section corresponding to the middle region of the fuel cell module 10 toward sections corresponding to the outer peripheral regions. The content ratio of the dry-out preventing heat storage material gradually increases in the order of the latent heat storage unit 50a, the latent heat storage unit 50b, and the latent heat storage unit 50c.

In general, the temperature of a fuel cell module is higher toward the center (highest in the center) and lower toward the exterior side. Accordingly, it is generally considered that the dry-out is more likely to occur in the middle region of the fuel cell module and the flooding is more likely to occur in the outer peripheral regions. In the third embodiment, the distribution of heat storage materials included in the latent heat storage unit 50 is varied. That is, the content ratio of the dry-out preventing heat storage material having a relatively high melting point is set to a large value in the region of the latent heat storage unit 50 corresponding to the middle region of the fuel cell module. And the content ratio of the flooding preventing heat storage material having a relatively low melting point is set to a large value in the regions thereof corresponding to the outer peripheral regions of the fuel cell module.

By employing the third embodiment, the optimum dry-out and flooding prevention can be done according to the temperature distribution of the fuel cell module 10. Thus the fuel cell can be operated more stably.

Though, in the present embodiment, the content ratios of the dry-out preventing heat storage material and the flooding preventing heat storage material are made to differ in stages for each region, the content of the dry-out preventing heat storage material may be decreased continuously from the middle region toward the outer peripheral regions of the fuel cell module 10.

The present invention is not limited to the above-described embodiments only, and it is understood by those skilled in the art that various modifications such as changes in design may be made based on their knowledge and the embodiments added with such modifications are also within the scope of the present invention.

In each of the above-described embodiments, a single pair of membrane electrode assemblies 12 is described as an example and the fuel cell is described as a single cell. A structure may be such that a plurality of membrane electrode assemblies 12 are disposed in a planar arrangement and the plurality of membrane electrodes 12 are connected in series by the use of electrical connecting components such as interconnectors, current collectors and wirings. The fuel cell to which the present embodiments are applicable may be of a stacked structure such that a plurality of membrane electrode assemblies 12 are stacked together.

What is claimed is:

1. A fuel cell module comprising:
a fuel cell including an electrolyte membrane, an anode disposed on one face of the electrolyte membrane and a cathode disposed on the other face of the electrolyte member;
a fuel containing unit configured to store hydrogen storage alloy for storing hydrogen to be supplied to said fuel cell; and
a latent heat storage unit including a first heat storage material having a melting point at or below which a dry-out begins during an operation of said fuel cell and a second heat storage material having a melting point at or above which a flooding begins during an operation of the fuel cell,
wherein said latent heat storage unit is thermally connected to said fuel cell and said fuel containing unit.

2. A fuel cell module according to claim 1, wherein said latent heat storage contains the first heat storage material and the second heat storage material such that the amount of the first heat storage material is greater than that of the second heat storage material, in a region corresponding to a middle region of the fuel cell, and
said latent heat storage contains the first heat storage material and the second heat storage material such that the amount of the second heat storage material is greater than that of the first heat storage material, in a region corresponding to a peripheral region of the fuel cell.

3. A fuel cell module according to claim 1, wherein the latent heat storage is demarcated into a plurality of portions from those corresponding to a middle region of said fuel cell toward those corresponding to a peripheral region, and
the content ratio of the second heat storage material in each of the portions gradually increases starting from a portion corresponding to the middle region toward a portion corresponding to an outermost region.

4. A fuel cell according to claim 1, wherein said latent heat storage unit, including the first heat storage material and the second heat storage material, contains a flexible material.

5. A fuel cell according to claim 2, wherein said latent heat storage unit, including the first heat storage material and the second heat storage material, contains a flexible material.

6. A fuel cell according to claim 3, wherein said latent heat storage unit, including the first heat storage material and the second heat storage material, contains a flexible material.

7. A fuel cell according to claim 1, wherein the melting point of the first heat storage material is less than or equal to a lower limit of a temperature at which a dry-out begins in a predetermined humidity range, and
wherein the melting point of the second heat storage material is greater than or equal to an upper limit of a temperature at which a flooding begins in a predetermined humidity range.

8. A fuel cell according to claim 2, wherein the melting point of the first heat storage material is less than or equal to a lower limit of a temperature at which a dry-out begins in a predetermined humidity range, and
wherein the melting point of the second heat storage material is greater than or equal to an upper limit of a temperature at which a flooding begins in a predetermined humidity range.

9. A fuel cell according to claim 3, wherein the melting point of the first heat storage material is less than or equal to a lower limit of a temperature at which a dry-out begins in a predetermined humidity range, and
wherein the melting point of the second heat storage material is greater than or equal to an upper limit of a temperature at which a flooding begins in a predetermined humidity range.

10. A fuel cell module according to claim 1, further comprising:
a temperature sensor configured to measure the temperature of said fuel cell; and
a control unit configured to lower an output of said fuel cell when the temperature measured by said temperature sensor rises to reach the melting point of the first heat storage material, and configured to raise the output of said fuel cell when the temperature measured by said temperature sensor drops to reach the melting point of the second heat storage material.

11. A fuel cell module according to claim 2, further comprising:
a temperature sensor configured to measure the temperature of said fuel cell; and
a control unit configured to lower an output of said fuel cell when the temperature measured by said temperature sensor rises to reach the melting point of the first heat storage material, and configured to raise the output of said fuel cell when the temperature measured by said temperature sensor drops to reach the melting point of the second heat storage material.

12. A fuel cell module according to claim 3, further comprising:
a temperature sensor configured to measure the temperature of said fuel cell; and
a control unit configured to lower an output of said fuel cell when the temperature measured by said temperature sensor rises to reach the melting point of the first heat storage material, and configured to raise the output of said fuel cell when the temperature measured by said temperature sensor drops to reach the melting point of the second heat storage material.

13. A fuel cell module according to claim 1, wherein said latent heat storage unit includes a plurality of first heat storage materials having a plurality of different melting points and a plurality of second heat storage materials having a plurality of different melting points,
wherein at least one of the plurality of first heat storage materials is a heat storage material, for use in restricting the dry-out, which has a melting point less than or equal to an upper limit of a temperature at which the dry-out begins, in different humidity ranges, and
wherein at least one of the plurality of second heat storage materials is a heat storage material, for use in restricting the flooding, which has a melting point greater than or equal to an upper limit of a temperature at which the flooding begins, in different humidity ranges.

14. A fuel cell module according to claim 2, wherein said latent heat storage unit includes a plurality of first heat storage materials having a plurality of different melting points and a plurality of second heat storage materials having a plurality of different melting points,
wherein at least one of the plurality of first heat storage materials is a heat storage material, for use in restricting the dry-out, which has a melting point less than or equal to an upper limit of a temperature at which the dry-out begins, in different humidity ranges, and
wherein at least one of the plurality of second heat storage materials is a heat storage material, for use in restricting the flooding, which has a melting point greater than or equal to an upper limit of a temperature at which the flooding begins, in different humidity ranges.

15. A fuel cell module according to claim 3, wherein said latent heat storage unit includes a plurality of first heat storage materials having a plurality of different melting points and a plurality of second heat storage materials having a plurality of different melting points,
wherein at least one of the plurality of first heat storage materials is a heat storage material, for use in restricting the dry-out, which has a melting point less than or equal to an upper limit of a temperature at which the dry-out begins, in different humidity ranges, and
wherein at least one of the plurality of second heat storage materials is a heat storage material, for use in restricting the flooding, which has a melting point greater than or equal to an upper limit of a temperature at which the flooding begins, in different humidity ranges.

16. A fuel cell module according to claim 13, further comprising:
a temperature sensor configured to measure the temperature of said fuel cell;
a humidity sensor configured to measure the humidity of said fuel cell; and
a control unit configured to lower an output of said fuel cell when the temperature measured by said temperature sensor rises to reach the melting point of the dry-out restricting heat storage material in a humidity range containing the humidity measured by said humidity sensor, and
configured to raise an output of said fuel cell when the temperature measured by said temperature sensor drops to reach the melting point of the flooding-restricting heat storage material in a humidity range containing the humidity measured by said humidity sensor.

17. A fuel cell module according to claim 14, further comprising:
a temperature sensor configured to measure the temperature of said fuel cell;
a humidity sensor configured to measure the humidity of said fuel cell; and
a control unit configured to lower an output of said fuel cell when the temperature measured by said temperature sensor rises to reach the melting point of the dry-out restricting heat storage material in a humidity range containing the humidity measured by said humidity sensor, and
configured to raise an output of said fuel cell when the temperature measured by said temperature sensor drops to reach the melting point of the flooding-restricting heat storage material in a humidity range containing the humidity measured by said humidity sensor.

18. A fuel cell module according to claim 15, further comprising:
a temperature sensor configured to measure the temperature of said fuel cell;
a humidity sensor configured to measure the humidity of said fuel cell; and
a control unit configured to lower an output of said fuel cell when the temperature measured by said temperature sensor rises to reach the melting point of the dry-out restricting heat storage material in a humidity range containing the humidity measured by said humidity sensor, and
configured to raise an output of said fuel cell when the temperature measured by said temperature sensor drops to reach the melting point of the flooding-restricting heat storage material in a humidity range containing the humidity measured by said humidity sensor.
